(19) United States
(12) Patent Application Publication
(10) Pub. No.: US 2016/0271543 A1
(43) Pub. Date: Sep. 22, 2016

(54) DUST COLLECTOR WITH FILTER CARTRIDGE(S)

(71) Applicant: AAF France, Gasny (FR)

(72) Inventors: Bruno Vincent, Pressagny l'Orgueilleux (FR); Olivier Baudoin, Daubeuf la Campagne (FR); Frederic Beaurin, Vernon (FR); Romain Lopes Neto, St Aubin sur Gaillon (FR)

(73) Assignee: AAF France, Gasny (FR)

(21) Appl. No.: 15/071,914

(22) Filed: Mar. 16, 2016

(30) Foreign Application Priority Data
Mar. 16, 2015 (FR) 1552096

(51) Int. Cl. B01D 46/00; F01D 25/32; B01D 46/24

(52) U.S. Cl. CPC B01D 46/0005; B01D 46/002; B01D 46/0068; B01D 46/2411; F01D 25/32

(57) ABSTRACT

A dust collector with at least one filter cartridge including a housing and an access door for each filter cartridge, each access door including a plate and a clamping element connected to the plate, wherein each access door is connected to the housing via a support arm connected to a double hinge attached to the outer face of the housing, the access door being adapted to slide with respect to the support arm according to a sliding clearance when the clamping element is released.

### CROSS REFERENCE TO RELATED APPLICATION

This application claims foreign priority under 35 USC 119 to French application no. 1552096 filed Mar. 16, 2015.

### FIELD OF THE INVENTION

The present invention relates to the field of industrial dust collectors, and particularly to a dust collector with filter cartridge(s).

### BACKGROUND OF THE INVENTION

Industrial dust collectors are used to filter air containing dry dust in suspension in a pollution area. The air is filtered therein via filter cartridges arranged in the dust collectors, the filter cartridges allowing for filtered clean air by separating dry dust from air, the dust being collected in collecting hoppers and reconditioned or destroyed according to the applications.

The conventional industrial dust collectors generally comprise access covers for accessing to the filter cartridges so as to service and/or replace the filter cartridges, these access covers being fluid-tight when arranged on the dust collectors. However, these access covers are not connected to the dust collector when opened, said covers are to be disposed at any location when removed from the dust collector, thereby increasing the time for the service and/or replacement of the filter cartridges by maintenance staff, thereby reducing the efficiency for servicing and/or replacing the filter cartridges. Further, the positioning of the access covers on the dust collector is inconvenient and their weight is often important.

European patent application EP1313542 discloses a dust collector with a filter structure, the filter structure comprising a filter supported by a yoke, one of the ends of which comprises a support element, the filter structure further comprising a cover configured to releasably couple to the support element of the yoke via a clamping element. However, the cover of the filter structure is not connected to the dust collector when the cover is uncoupled from the support element of the yoke of the filter structure, said cover having to be disposed at any location when removed from the dust collector, thereby increasing the time for the service and/or replacement of the filter structure by maintenance staff, thereby reducing the efficiency for servicing and/or replacing the filter structure.

European patent application EP0398091 discloses an air filter with horizontal filter elements, doors facing the filter elements to access thereto, each door being connected to the outer wall of the air filter by a hinge. However, the doors when closed are not coupled to the supports of the filter elements, thus posing a problem for maintaining in position the ends of the filter elements facing the doors, and also reducing the sealing efficiency of the doors when closed.

So-called self-cleaning industrial dust collectors further comprise nozzles for declogging by counter-current compressed air, which clean the filter cartridges by injecting therein a counter-current compressed air flow. However, cleaning of the filter cartridges is not uniform because the pressurized air flow coming out from a declogging nozzle generally forms a conical air volume with a marked acute angle, the parts of the filter cartridges away from the declogging nozzles being correctly cleaned while the parts of the filter cartridges near the declogging nozzles are not correctly cleaned, thus causing dust to build-up on the parts of the filter cartridges near the declogging nozzles, thereby reducing the performance of the dust collector, and forcing the maintenance staff to replace more often the filter cartridges.

### BRIEF SUMMARY OF THE INVENTION

The present invention is intended to solve the disadvantages of the prior art by providing a dust collector with filter cartridge(s) having an access door for each filter cartridge, each access door being connected to the housing of the dust collector via a support arm hinged on the housing by a double hinge and being configured to releasably couple to the support of the corresponding filter cartridge via a clamping element, each access door further being adapted to slide with respect to the support arm according to a sliding clearance when the clamping element is released so as to uncouple the access door from the filter cartridge support, each filter cartridge support optionally comprising one or more baffles to improve the declogging of the filter cartridge.

The present invention thus relates to a dust collector with filter cartridge(s), comprising:

a housing comprising an air inlet, an air outlet, and an inner separation wall separating the housing into a filtering chamber and a filtered air chamber, the air inlet opening onto the filtering chamber, the filtered air chamber leading to the exterior via the air outlet, one or more air flow openings being formed in the separation wall to establish a fluid communication between the filtering chamber and the filtered air chamber;

one or more filter cartridges arranged in the filtering chamber, each being in fluid communication with a respective air flow opening in the separation wall, each filter cartridge comprising:

a support having a first end connected to the separation wall and a second end opposite to the first end and carrying a blocking element;

a hollow filter, opened at both ends, and sleeved on the support, a first end of the filter being sealingly arranged against the corresponding air flow opening in the separation wall such that there is a fluid communication between the interior of the filter and the corresponding air flow opening in the separation wall;

one or more hoppers for collecting the dust formed in the bottom of the filtering chamber so as to collect the dust generated from the filtering of the filter cartridge(s); and an access door for each filter cartridge, each access door opening onto the second end of the corresponding filter, each access door comprising:

a plate for covering the opening in the second end of the corresponding filter when the access door is closed;

a clamping element connected to the plate; and

a coupling element operably connected to the clamping element and configured to couple to the blocking element of the corresponding filter cartridge support, the plate being configured to seal the opening in the second end of the corresponding filter when the access door is closed by coupling the coupling element to the blocking element and using the clamping element to move the plate towards the blocking element;

characterized in that each access door is connected to the housing via a support arm hinged on the outer face of the housing by a double hinge, the access door being configured to slide in the plane of the plate with respect to the support arm according to a sliding clearance when the clamping element is released, such that the coupling element is adapted to be uncoupled from the blocking element, when the clamping element is released, by sliding the access door with respect to the support arm.

In operation, a depression is formed in the dust collector using an outer turbine connected to the air outlet of the dust collector or a fan embedded in the dust collector, thereby causing the “polluted” air, containing dry particles in suspension, present at the location where the dust collector is installed, to be sucked in the filtering chamber of the dust collector via the air inlet of the housing. Then, the polluted air radially passes through the filter cartridges and is thus filtered by the outer wall of the filter cartridges, the filters separating the dry dust from air. The filtered air then penetrates the filtered air chamber via air flow openings in the separation wall, and exits the dust collector via the air outlet of the housing, the dry dust falling by gravity in the collecting hoppers disposed below the filtering chamber or being attached to the outer wall of the filters of the filter cartridges.

The access doors of the dust collector allow to easily perform the service and/or replacement, by maintenance staff, of the filter cartridges disposed in the filtering chamber of the housing, these access doors being configured to seal the second ends of the filters of the filter cartridges by coupling the coupling element of an access door to the blocking element of the support of a filter cartridge, and clamping the clamping element of the access door so as to move the access door towards the blocking element and thus seal the second end of the filter of the filter cartridge with the plate of the access door.

In the present description, the expression “double hinge” means a hinge comprising first and second parallel hinges connected to each other by an arm, the first hinge being attached to the outer wall of the housing and the second hinge being movable with respect to the first hinge while being parallel to the first hinge.

An example of double hinge is a double hinge, model 37-19, of the Emile Maurin company.

The support arm connected to the double hinge allows to connect the access door to the housing of the dust collector even when the access door is uncoupled from the filter cartridge support by releasing the clamping element and sliding the access door in the plane of the plate with respect to the support arm according to the sliding clearance, the double hinge allowing to move by translation the access door away from/closer to the outer wall of the housing when releasing/clamping the clamping element, and also to rotatably open the access door.

Thus, the time for servicing and/or replacing the filter cartridges by maintenance staff is reduced, thereby improving the efficiency for servicing and/or replacing the filter cartridges.

The dust collector according to the invention can be connected to a downstream device for which the air is filtered, or mounted on a base and connected to the downstream device for which the air is filtered by a sealed air duct.

According to a particular feature of the invention, each support arm comprises a hole formed facing the blocking element of the support of the corresponding filter cartridge, a strut connected to the clamping element of the corresponding access door being arranged within said hole, the sliding clearance of the access door with respect to the support arm being formed by a spacing between the strut and the edge of the hole.

Thus, the spacing between the strut and the edge of the hole creates a sliding clearance of the access door with respect to the support arm, said sliding clearance allowing to uncouple the coupling element from the blocking element, when the clamping element is released, by sliding the access door by an operator.

It can be noted that a sliding washer parallel to the plate of the access door and attached to the clamping element could be disposed against the support arm, the support arm being arranged between the plate and the sliding washer, so as to guide the sliding of the access door in the plane of the plate, without departing from the scope of the present invention.

According to a particular feature of the invention, two double hinges respectively connected to two support arms of two adjacent access doors have their hinge attached to the housing in common so as to form a single triple hinge.

Thus, a single triple hinge is required for two adjacent access doors, thereby allowing to reduce the manufacturing costs of the dust collector.

The central hinge common to both adjacent doors allows to rotatably open the doors, and the other two hinges of the triple hinge respectively allow to move both doors away from/closer to the wall of the housing by translation.

According to a particular feature of the invention, a seal is arranged on the edge and/or periphery of each plate.

Thus, the seal allows to improve the sealing efficiency of the access door when closed, the seal preferably abutting against the outer wall of the housing.

According to a particular feature of the invention, the clamping element is a pusher clamping device.

Thus, the clamping of the handle of the pusher clamping device by an operator allows to pull the pusher in the device and, when the coupling element is coupled to the blocking element, to move the plate of the access door closer to the filter cartridge support.

In addition, the release of the handle of the pusher clamping device by an operator allows to pull the pusher out of the device and, when the coupling element is coupled to the blocking element, to move the plate of the access door away from the filter cartridge support.

A reference of pusher clamping device is, for example, a push-pull clamp, reference GG.AG411, of the Elesa company.

According to a particular feature of the invention, the blocking element is a C-shaped open washer, the opening of the washer being oriented upwards, configured to cooperate with a coupling element in the form of a screw, the rod of which can go through the open washer, and the head of which is adapted to abut against the washer.

Thus, the opening of the open washer allows to releasably receive the screw of the coupling element of an access door.

The screw head can easily and releasably be coupled to the open washer of the blocking element, the diameter of the screw rod being slightly lower than the spacing of the opening of the open washer, the diameter of the screw head being higher than the spacing of the opening of the open washer such that the head is adapted to abut against the washer when the rod is inside the open washer.

According to a particular feature of the invention, an adjusting nut is arranged on the screw to adjust the distance between the screw head and the plate of an access door.

Thus, the coupling elements of the access doors can be adjusted according to the type of filter cartridges used.

Further, an accurate adjustment can also be performed for each access door according to the tolerances of the corresponding filter cartridge.

According to a particular feature of the invention, each support comprises three equidistant bent rods, the bent parts of the three rods being connected to the blocking element and the other parts of the three rods being configured to embed in holes formed in the separation wall of the housing.

The non-bent parts of the three rods can be parallel and form in cross-section the three vertices of an equilateral triangle.

The three rods are preferably made of metal, but could also be made of plastic material without departing from the scope of the present invention.

Each support could also comprise one or more triangle-shaped hollow support frames, the three vertices of the triangle of each support frame being respectively welded to the three rods, without departing from the scope of the present invention.

According to a particular feature of the invention, each filter comprises several filter elements successively arranged on the support of the corresponding filter cartridge, each link between two filter elements being fluid tight.

The filter elements can be made of textile or paper material, the filter elements comprising microscopic holes such that the air can pass through them, but not the dust.

Each filter element preferably comprises a hollow circular cross-sectional section so as to be inserted on the filter cartridge support.

According to a particular feature of the invention, the dust collector with filter cartridge(s) further comprises one or more nozzles for declogging by counter-current compressed air, which nozzles are arranged in the filtered air chamber and respectively oriented towards the one or more air flow openings in the separation wall.

The penetration of the air in the filter cartridges causes a deposition of dust at the periphery of the cartridges. However, the fouling of the cartridges causes a pressure loss which causes a high pressure difference between the dirty air volume and the clean air volume.

The declogging nozzles allow to clean the filters of the filter cartridges by projecting counter-current compressed air in the filter cartridges, thereby allowing the removal of dust deposited on the outer faces of the filters, the dust then falling by gravity in the collecting hoppers.

Thus, the pressure difference value is reduced, allowing the dust collector to resume normal operation.

According to a particular feature of the invention, each filter cartridge support comprises one or more hollow baffles, each hollow baffle being configured to deflect, towards the inner wall of the filter, a part of the compressed air flow provided by the corresponding nozzle, the other part of the compressed air flow passing through the baffle.

The baffle(s) is/are preferably disposed on the support near the declogging nozzle, namely the location where the filters are not correctly cleaned in the prior art. The baffle(s) is/are preferably in a plane perpendicular to the longitudinal plane of the filter cartridge to deflect the air flow from the declogging nozzle which propagates in the longitudinal direction of the filter cartridge, in the direction opposite to the normal air flow in the filter cartridges, from the air inlet to the air outlet of the dust collector.

Thus, the cleaning of a filter cartridge is uniform on its entire length, thereby increasing the performance of the dust collector and reducing the replacement frequency of the filter cartridges.

For each baffle, the face of the baffle oriented towards the declogging nozzle comprises angular parts so as to deflect a part of the compressed air flow towards the inner wall of the filter of the filter cartridge, the other part of the compressed air flow passing through the hollow part of the baffle.

The baffle(s) is/are preferably made of metal.

Each baffle can have a triangular, circular or square shape, the baffle being welded to the three rods of the filter cartridge support.

According to a particular feature of the invention, each baffle comprises holes on all or part of its surface.

The holes, preferably millimetric holes, are small enough such that the baffle ensures the declogging function, and allow to limit the increase of air speed in the filter cartridge and thus prevent a pressure loss.

According to a particular feature of the invention, the dust collector with filter cartridge(s) further comprises a fan to create an air flow between the air inlet and the air outlet of the housing.

Thus, the fan allows to create a depression in the dust collector, thereby causing the “polluted” air, containing dry particles in suspension, present at the location where the dust collector is installed, to be sucked in the filtering chamber of the dust collector via the air inlet of the housing.

The present invention also relates to a turbine equipped with a dust collector with filter cartridge(s) according to the present invention.

Thus, the turbine allows to create a depression in the dust collector, thereby causing the “polluted” air, containing dry particles in suspension, present at the location where the dust collector is installed, to be sucked in the filtering chamber of the dust collector via the air inlet of the housing.

### BRIEF DESCRIPTION OF THE DRAWINGS

To better understand the subject-matter of the present invention, for illustrating and non-limiting purposes, a preferred embodiment will be described below with reference to the appended drawings.

In these drawings:

FIG. 1 is a perspective view of a dust collector according to the present invention;

FIG. 2 is an exploded view of a support of filter cartridge and an access door of the dust collector of FIG. 1;

FIG. 3a is a cross-sectional view of the closed access door of the dust collector of FIG. 1, the clamping element of which is clamped;

FIG. 3b is a cross-sectional view of the closed access door of FIG. 3a, the clamping element of which is released;

FIG. 3c is a cross-sectional view of the access door of FIG. 3a, the clamping element of which is released and the coupling element of which is uncoupled;

FIG. 4 is a perspective view of the dust collector of FIG. 1, an access door of which is opened; and

FIG. 5 is a cross-sectional view of a filter cartridge of the dust collector of FIG. 1, disposed in front of a declogging nozzle of the dust collector.

### DETAILED DESCRIPTION OF THE INVENTION

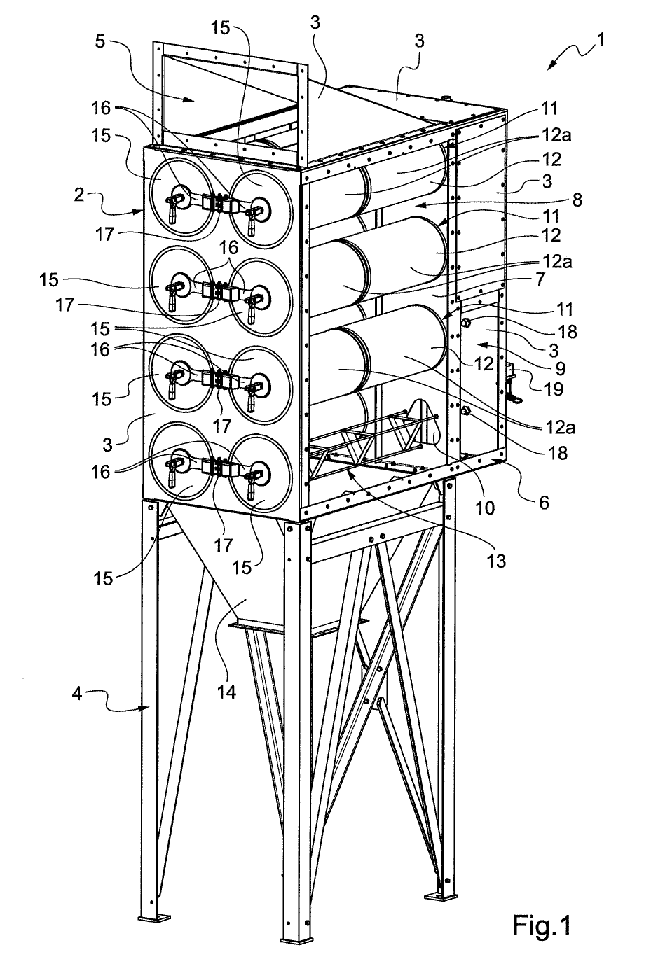

When referring to FIG. 1, a dust collector 1 with filter cartridges according to the present invention is shown.

It can be noted that some of the side walls of the dust collector 1 are not shown so as to better understand the drawing.

The dust collector 1 with filter cartridges comprises a housing 2 formed of lateral and upper metal walls 3.

The housing 2 is disposed on a support frame 4.

The housing 2 comprises an air inlet 5 at its upper part, an air outlet 6 at its lower part, and an inner separation wall 7 separating the housing 2 into a filtering chamber 8 and a filtered air chamber 9 which are contiguous.

The air inlet 5 opens onto the filtering chamber 8, the filtered air chamber 9 leads to the exterior through the air outlet 6, and the separation wall 7 comprises air flow openings 10 allowing a fluid communication between the filtering chamber 8 and the filtered air chamber 9.

The dust collector 1 further comprises filter cartridges 11 horizontally arranged in the filtering chamber 8, perpendicular to the separation wall 7, each of them being in fluid communication with a respective air flow opening 10 in the separation wall 7.

In this non-limiting embodiment, the dust collector 1 comprises two adjacent columns of four filter cartridges 11.

It can be noted that the dust collector 1 could comprise any number of filter cartridges 11 arranged according to any number of columns and rows, in any arrangement, without departing from the scope of the present invention.

Each filter cartridge 11 comprises a filter 12 sleeved on a support 13, each filter 12 comprising two filter elements 12a successively arranged on the corresponding support 13, each filter element 12a being cylindrical and hollow and having a circular-shaped cross section, each link between two adjacent filter elements 12a being fluid-tight.

The filter elements 12a are made of paper or textile material and comprise microscopic holes such that the air can radially pass through them, but not the dust.

It can be noted that each filter 12 could be made of a single filter element 12a or of at least three filter elements 12a, without departing from the scope of the present invention.

The filter elements 12a of one of the filter cartridges 11 are not shown so as to represent the support 13 of the filter cartridge 11.

The support 13 of filter cartridge 11 will be described in more detail below.

The first end of each filter 12 is sealingly arranged against the corresponding air flow opening 10 in the separation wall 7, such that there is a fluid communication between the interior of the filter 12 and the corresponding air flow opening 10 in the separation wall 7. The second end of each filter 12 is adjacent to the lateral metal wall 3 opposite to the separation wall 7 in the filtering chamber 8.

The dust collector 1 also comprises a hopper 14 for collecting the dust disposed below the filter cartridges 11, formed in the bottom of the filtering chamber 8 which opens onto the hopper 14.

It can be noted that the dust collector 1 could comprise several hoppers 14, for example one below each column of filter cartridges, without departing from the scope of the present invention.

A depression is formed in the dust collector 1 using an external turbine (not shown in FIG. 1) connected to the air outlet 6 of the dust collector 1 to create an air flow between the air inlet 5 and the air outlet 6 of the housing 2, causing the “polluted” air, containing dry particles in suspension, present at the location where the dust collector 1 is installed, to be sucked in the filtering chamber 8 of the dust collector 1 via the air inlet 5 in the upper part of the housing 2. Then, the polluted air radially passes through the filters 12 of the filter cartridges 11 and is thus filtered by the filters 12 of the filter cartridges 11, the filters 12 separating dry dust from air. The filtered air then penetrates the filtered air chamber 9 via the air flow openings 10 in the separation wall 7, and exits the dust collector 1 via the air outlet 6 of the housing 2, the dry dust falling by gravity in the hopper 14 disposed below the filtering chamber 8 or sticking on the outer wall of the filters 12 of the filter cartridges 11.

It can be noted that the depression in the dust collector 1 could also be created by a fan integrated to the dust collector 1 to create an air flow between the air inlet 5 and the air outlet 6 of the housing 2, without departing from the scope of the present invention.

The dust collector 1 further comprises an access door 15 for each filter cartridge 11, each access door 15 opening onto the second end of the corresponding filter 12 adjacent to the lateral metal wall 3 opposite to the separation wall 7 in the filtering chamber 8.

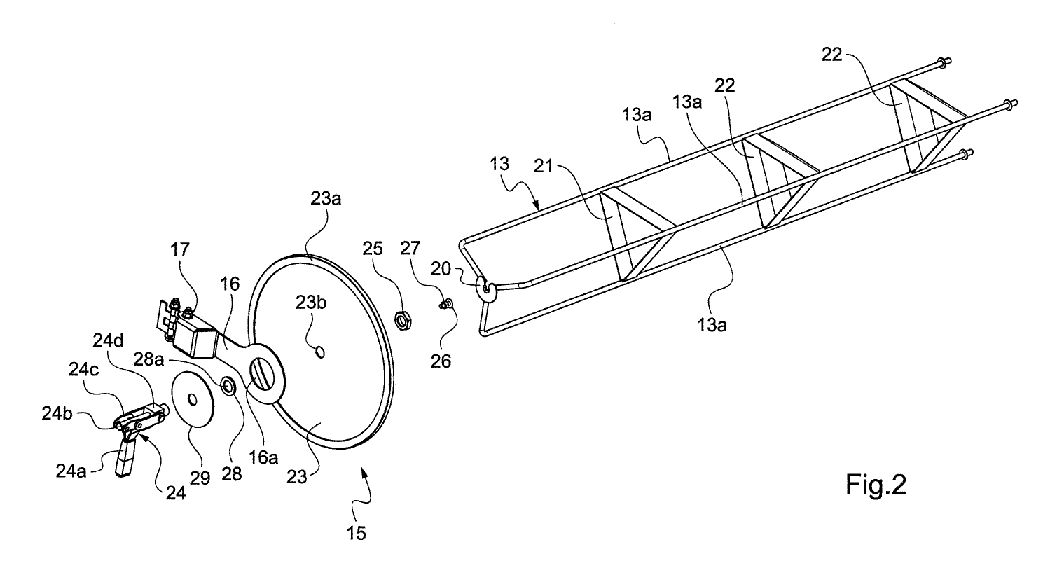

The access doors 15 will be described in more detail with reference to FIG. 2.

Each access door 15 is connected to the housing 2 via a support arm 16 connected to a triple hinge 17 attached to the outer face of the lateral metal wall 3 adjacent to the second ends of the filters 12.

Two support arms 16 of two horizontally adjacent access doors 15 are connected to the same triple hinge 17, said triple hinge 17 comprising a central hinge common to both support arms 16, attached on the wall of the housing 2.

It can be noted that each support arm 16 could also be connected to a double hinge, two adjacent support arms 16 then being connected to two separate double hinges, without departing from the scope of the present invention.

The access doors 15 allow to easily service and/or replace, by maintenance staff, the filter cartridges 11 arranged in the filtering chamber 8 of the housing 2, these access doors 15 being configured, when closed, to seal the second ends of the filters 12 of the filter cartridges 11.

The dust collector 1 further comprises nozzles 18 for declogging by counter-current compressed air, which nozzles 18 are arranged in the filtered air chamber 9, respectively oriented towards the air flow openings 10 in the separation wall 7, the declogging nozzles 18 being provided with compressed air by a compressed air tank 19 disposed at the rear of the dust collector 1.

The declogging nozzles 18 allow to clean the filters 12 of the filter cartridges 11 by projecting compressed air in the filter cartridges 11, in the direction opposed to the air flow during a normal operation of the dust collector 1, thereby allowing to remove the dust deposited on the outer walls of the filters 12, the dust then falling by gravity in the hopper 14.

It can be noted that a container (not shown in FIG. 1) could be disposed below the hopper 14 so as to collect the dust falling within the hopper 14.

When referring to FIG. 2, a support 13 of filter cartridge 11 and an exploded view of an access door 15 of the dust collector 1 are shown.

The support or yoke 13 comprises three equidistant metal bent rods 13a, the bent parts of the three rods 13a being connected to a blocking element 20 and the other parts of the three rods 13a being configured to be embedded in holes formed within the separation wall 7 of the housing 2 of the dust collector 1, the blocking element 20 being a C-shaped open washer, the opening of the C being oriented upwards and the rods 13a being attached to the C-shaped washer, for example by welding.

It can be noted that the support 13 could also comprise at least four rods 13a, without departing from the scope of the present invention.

The ends of the rods 13a can, for example, be friction fitted in the separation wall 7 or can be threaded so as to be bolted on the separation wall 7 from the filtered air chamber 9.

The support 13 also comprises a triangle-shaped hollow metal reinforcement 21, the three vertices of the reinforcement 21 being respectively welded to the three rods 13a.

The support 13 further comprises two hollow baffles 22, each hollow baffle 22 being configured to deflect, towards the inner wall of the corresponding filter 12, a part of the compressed air flow provided by the corresponding declogging nozzle 18, the other part of the compressed air flow passing through the baffle 22.

It can be noted that the support 13 could have no baffle 22 or have a single baffle 22 or at least three baffles 22, without departing from the scope of the present invention.

The baffles 22 are disposed on the part of the support 13 near the declogging nozzle 18.

The baffles 22 are made of metal and have a cross-sectional triangle shape, the vertices of the baffles 22 being respectively welded to the three rods 13a of the support 13.

The baffles 22 will be described in more detail with reference to FIG. 5.

It can be noted that the baffles 22 could also have a cross-sectional circular or square shape, without departing from the scope of the present invention, provided that the deflection function of the air flow from the declogging nozzle 18 is provided.

The access door 15 comprises a circular plate 23 configured to cover the opening in the second end of the corresponding filter 12 when the access door 15 is closed, a seal 23a being disposed on the edge of each plate 23.

The access door 15 also comprises a clamping element 24, the clamping element 24 being a pusher clamping device comprising a handle 24a, the handle 24a being connected to a rod 24b and rotatably coupled to a connecting element 24c connected to a support block 24d in which the rod 24b is slidably inserted.

One of the ends of the support block 24d passes through a central hole 16a in the support arm 16 and a central hole 23b in the plate 23, a clamping nut 25 disposed on the support 13 side being screwed on said end of the support block 24d so as to attach the clamping element 24 to the plate 23.

The access door 15 further comprises a coupling element 26 configured to couple to the blocking element 20 of the support 13, the coupling element 26 being a screw screwed in the end of the rod 24b of the clamping element 24 facing the blocking element 20.

The rod of the screw 26 is adapted to enter the open washer 20 and the head of the screw 26 is adapted to abut against the washer 20 when the rod of the screw 26 is inside the open washer 20.

An adjustment nut 27 is disposed on the rod of the screw 26 to adjust the distance between the head of the screw 26 and the plate 23 of the access door 15.

The clamping of the handle 24a of the pusher clamping device 24 by an operator allows to pull the rod 24d in the pusher clamping device 24 and, when the coupling element 26 is coupled to the blocking element 20, to move the plate 23 closer to the support 13.

In addition, the release of the handle 24a from the pusher clamping device 24 by an operator allows to pull the rod 24b out of the pusher clamping device 24 and, when the coupling element 26 is coupled to the blocking element 20, to move the plate 23 away from the support 13.

A strut 28 with a central hole 28a, in which the support block 24d of the clamping element 24 is inserted, is arranged within the central hole 16a of the support arm 16, a sliding clearance of the access door 15 with respect to the support arm 16 being formed by a spacing between the strut 28 and the edge of the central hole 16a of the support arm 16.

A sliding washer 29 parallel to the plate 23 is disposed between the clamping element 24 and the support arm 16 so as to guide the sliding of the access door 15 in the plane of the plate 23, the support block 24d of the clamping element 24 being inserted in the sliding washer 29.

Thus, the formed sliding clearance allows to couple/uncouple the coupling element 26 to/from the blocking element 20, when the clamping element 24 is released, by sliding the access door 15 by an operator with respect to the support arm 16.

The plate 23 is thus configured to seal the opening in the second end of the corresponding filter 12 by coupling the coupling element 26 to the blocking element 20, then using the clamping element 24 to move the plate 23 towards the blocking element 20.

It can be noted that only two hinges of the triple hinge 17 have been shown in FIG. 2, said two hinges being the two hinges associated with the access door 15 shown.

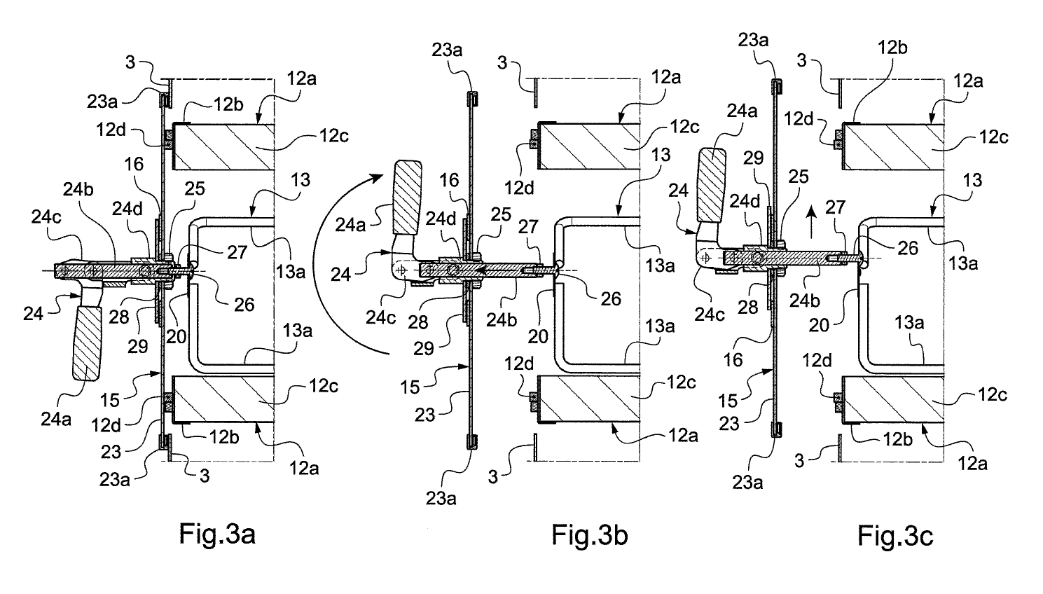

When referring to FIGS. 3a, 3b and 3c, the opening kinematics of an access door 15 of the dust collector 1 is shown.

Each filter element 12a has rigid washers 12b at its both ends, the rigid washers 12b serving as fixing support for the paper or textile element 12c of the filter element 12a.

A seal 12d is disposed on each outer face of rigid washer 12b of filter element 12a, such that a link between two filter elements 12a is fluid-tight, the link between a filter element 12a and the separation wall 7 is fluid-tight, and the link between a filter element 12a and the plate 23 of the access door 15, when the access door 15 is closed, is fluid-tight.

In particular, when referring to FIG. 3a, it can be seen that the access door 15 is closed.

The screw 26 of the access door 15 is coupled to the open washer 20 of the filter cartridge 11 support 13.

The handle 24a of the clamping element 24 is clamped, namely oriented downwards, such that the rod 24b is pulled in the clamping element 24.

Thus, the strut 28 is disposed at the center of the central hole 16a of the support arm 16 and the plate 23 is moved closer to the support 13, such that the edge of the plate 13 is in contact with the side wall 3 of the dust collector 1, the seal 23a abutting against the side wall 3 of the dust collector 1.

In addition, the plate 23 of the access door 15 is in contact with the seal 12d of the filter element 12a facing the access door 15, such that the opening in the second end of the filter 12 is sealed.

When referring now to FIG. 3b, it can be seen that the handle 24a of the clamping element 24 is released by an operator, namely oriented upwards.

The release of the handle 24a causes the rod 24b to pull out the clamping element 24.

The screw 26 being still coupled to the open washer 20 of the support 13, the plate 23 of the access door 15 thus moves away by translation from the filter cartridge 11 support 13, the plate 23 remaining parallel to the side wall 3 of the dust collector 1 because the associated non-central hinge of the triple hinge 17 rotates with respect to the central hinge of the triple hinge 17, and due to the sliding clearance between the access door 15 and the support arm 16.

Thus, the opening in the second end of the filter 12 is opened.

Finally, when referring to FIG. 3c, it can be seen that the access door 15 is raised by an operator.

The raising of the access door 15 causes the screw 26 to be uncoupled from the open washer 20 of the support 13.

Said raising is possible by the sliding clearance between the strut 28 and the edge of the central hole 16a of the support arm 16, the strut 28 abutting against the upper edge of the central hole 16a of the support arm 16 when the access door 15 is raised, thereby allowing the head of the screw 26 to be uncoupled from the open washer 20, the support 13 remaining attached to the separation wall 7 by its rods 13a.

After uncoupling the screw 26 from the open washer 20, the access door 15 can then be entirely opened by an operator, using the rotation of the central hinge of the triple hinge 17, allowing to service and/or replace the corresponding filter cartridge 11 by the operator, without separating the access door 15 from the housing 2.

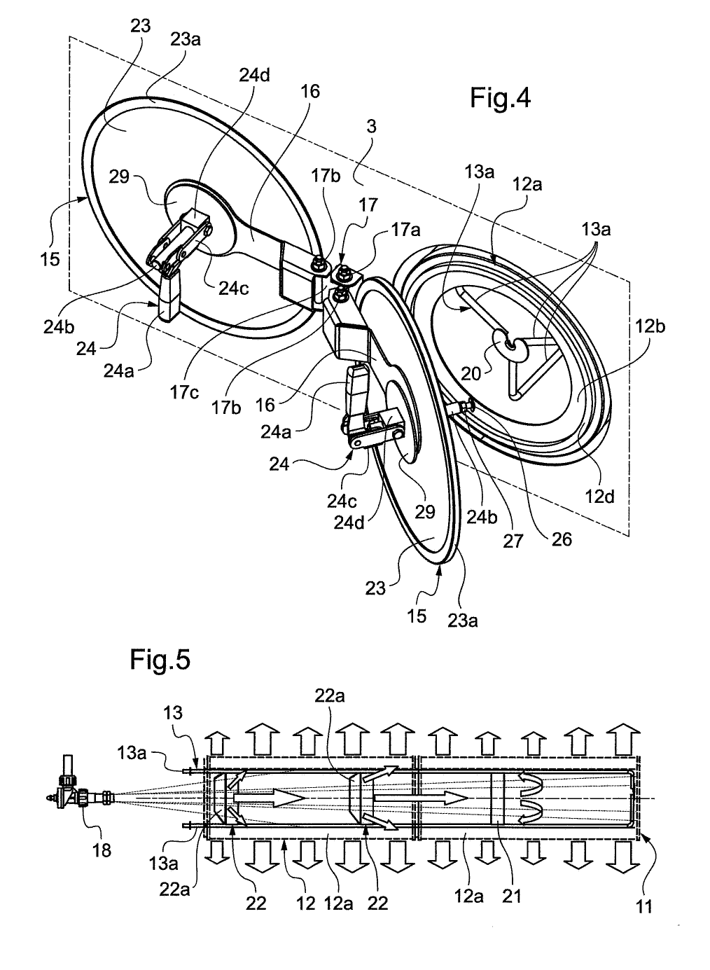

When referring to FIG. 4, two adjacent access doors 15 of the dust collector 1 are shown, one of both access doors 15 being opened and the other of both access doors 15 being closed.

The strut 28 of the open access door 15 abuts against the lower edge of the central hole 16a of the support arm 16 when the open access door 15 is not held by an operator, thus the center of the sliding washer 29 of the open access door 15 is lower than the center of the hole 16a of the support arm 16.

The support arms 16 of both adjacent access doors 15 are connected to a single triple hinge 17.

The triple hinge 17 comprises a common central hinge 17a and two other hinges 17b respectively associated with both adjacent access doors 15, each hinge 17b being connected to the central hinge 17a by an arm 17c, the central hinge 17a being attached to the side wall 3 of the housing 2, and the two other hinges 17b being movable with respect to the central hinge 17a.

Thus, the triple hinge 17 allows both to move, by translation, one or both adjacent access doors 15 away from/closer to the side wall 3 of the housing 2 when releasing/clamping the corresponding clamping element 24, and also to rotatably open the adjacent access door(s) 15.

When referring to FIG. 5, the compressed air flow injected by a declogging nozzle 18 in a filter cartridge 11 is shown.

When the admissible maximum value of the depression between the dirty air volume and the clean air volume is reached, a sequencer (not shown in FIG. 5) sends a signal to the declogging nozzle 18 for triggering the declogging.

As a result, a compressed air volume is released by the declogging nozzle 18, the compressed air volume being injected in the filter cartridge 11 in the direction opposite to the air flow treated by the filter cartridge 11.

As a result, it increases the air pressure, by a shock wave, within the filter cartridge 11, the combination of this shock wave and of the pressure increase causing the dust in the filtering chamber 8 to be removed, the dust thus removed from the filter 12 then falling by gravity in the collecting hopper 14.

The rebound of the compressed air volume within the filter cartridge 11, on the plate 23 of the access door 15, allows an efficient declogging of the part of the filter 12 opposite to the declogging nozzle 18.

The baffles 22 of the filter cartridge 11 support 13 are disposed on the part of the support 13 near the declogging nozzle 18, namely the location where the filter 12 is not correctly cleaned in the prior art.

For each baffle 22, the face of the baffle 22 oriented towards the declogging nozzle 18 comprises angular parts 22a configured to deflect a part of the compressed air flow towards the inner wall of the filter 12 of the filter cartridge 11, the other part of the compressed air flow passing through the hollow part of the baffle 22.

Thus, the cleaning of the filter 12 of the filter cartridge 11 is uniform on the entire length of the filter 12, thereby allowing to increase the performance of the dust collector 1 and to reduce the replacement frequency of the filter cartridge 11.

It can be noted that each baffle 22 could also have, on its entire surface, holes, preferably millimetric holes, so as to limit the increase of the air speed in the filter cartridge 11 and thus to prevent a loss of pressure, without departing from the scope of the present invention.

The present invention also relates to a turbine provided with a dust collector with filter cartridges 1 according to the present invention.

1. A dust collector comprising:
a housing comprising an air inlet, an air outlet, and an inner separation wall separating the housing into a filtering chamber and a filtered air chamber, the air inlet opening onto the filtering chamber, the filtered air chamber leading to the exterior via the air outlet, at least one air flow opening being formed in the separation wall to establish a fluid communication between the filtering chamber and the filtered air chamber;
at least one filter cartridge arranged in the filtering chamber, each filter cartridge being in fluid communication with a respective air flow opening in the separation wall, each filter cartridge comprising:
a support having a first end connected to the separation wall and a second end opposite to the first end and carrying a blocking element;
a hollow filter, opened at its two ends, and sleeved on the support, a first end of the filter being sealingly arranged against the corresponding air flow opening in the separation wall such that there is a fluid communication between the interior of the filter and the corresponding air flow opening in the separation wall;
at least one hopper for collecting the dust formed in the bottom of the filtering chamber so as to collect the dust from the filtering of the at least one filter cartridge; and
an access door for each filter cartridge, each access door opening onto the second end of the corresponding filter, each access door comprising:
a plate for covering the opening in the second end of the corresponding filter when the access door is closed;
a clamping element connected to the plate; and
a coupling element operably connected to the clamping element and configured to couple to the blocking element of the corresponding filter cartridge support, the plate being configured to seal the opening in the second end of the corresponding filter when the access door is closed by coupling the coupling element to the blocking element and using the clamping element to move the plate towards the blocking element;
wherein each access door is connected to the housing via a support arm hinged on the outer face of the housing by a double hinge, the access door being configured to slide in the plane of the plate with respect to the support arm according to a sliding clearance when the clamping element is released, such that the coupling element is adapted to be uncoupled from the blocking element, when the clamping element is released, by sliding the access door with respect to the support arm.

2. The dust collector according to claim 1, wherein each support arm comprises a hole formed facing the blocking element of the support of the corresponding filter cartridge, a strut connected to the clamping element of the corresponding access door being arranged within the hole, the sliding clearance of the access door with respect to the support arm being created by a spacing between the strut and the edge of the hole.

3. The dust collector according to claim 1, wherein two double hinges respectively connected to two support arms of two adjacent access doors have their hinge attached to the housing in common so as to form a single triple hinge.

4. The dust collector according to claim 1, wherein a seal is arranged on at least one of the edge and/or periphery of each plate.

5. The dust collector according to claim 1, wherein the clamping element is a pusher clamping device.

6. The dust collector according to claim 1, wherein the blocking element is a C-shaped open washer, the opening of the washer being oriented upwards, configured to cooperate with a coupling element in the form a screw, the rod of the screw being adapted to go through the washer, and the head of the screw being adapted to abut against the washer.

7. The dust collector according to claim 6, wherein an adjusting nut is arranged on the screw to adjust the distance between the screw head and the plate of an access door.

8. The dust collector according to claim 1, wherein each support comprises three equidistant bent rods, the bent parts of the three rods being connected to the blocking element and the other parts of the three rods being configured to embed into holes formed in the separation wall of the housing.

9. The dust collector according to claim 1, wherein each filter comprises several filter elements successively arranged on the support of the corresponding filter cartridge, each link between two filter elements being fluid-tight.

10. The dust collector according to claim 1, wherein the dust collector further comprises at least one nozzle for declogging by counter-current compressed air, the at least one nozzle being arranged in the filtered air chamber and respectively oriented towards the at least one air flow opening in the separation wall.

11. The dust collector according to claim 10, wherein each support of filter cartridge comprises at least one hollow baffle, each hollow baffle being configured to deflect, towards the inner wall of the filter, a part of the compressed air flow provided by the corresponding nozzle, the other part of the compressed air flow passing through the baffle.

12. The dust collector according to claim 11, wherein each baffle comprises holes on at least a part of its surface.

13. The dust collector according to claim 1, wherein the dust collector further comprises a fan to create an air flow between the air inlet and the air outlet of the housing.

14. A turbine comprising a dust collector , said dust collector comprising:
a housing comprising an air inlet, an air outlet, and an inner separation wall separating the housing into a filtering chamber and a filtered air chamber, the air inlet opening onto the filtering chamber, the filtered air chamber leading to the exterior via the air outlet, at least one air flow opening being formed in the separation wall to establish a fluid communication between the filtering chamber and the filtered air chamber;
at least one filter cartridge arranged in the filtering chamber, each filter cartridge being in fluid communication with a respective air flow opening in the separation wall, each filter cartridge comprising:
a support having a first end connected to the separation wall and a second end opposite to the first end and carrying a blocking element;
a hollow filter, opened at its two ends, and sleeved on the support, a first end of the filter being sealingly arranged against the corresponding air flow opening in the separation wall such that there is a fluid communication between the interior of the filter and the corresponding air flow opening in the separation wall;
at least one hopper for collecting the dust formed in the bottom of the filtering chamber so as to collect the dust from the filtering of the at least one filter cartridge; and
an access door for each filter cartridge, each access door opening onto the second end of the corresponding filter, each access door comprising:
a plate for covering the opening in the second end of the corresponding filter when the access door is closed;
a clamping element connected to the plate; and
a coupling element operably connected to the clamping element and configured to couple to the blocking element of the corresponding filter cartridge support, the plate being configured to seal the opening in the second end of the corresponding filter when the access door is closed by coupling the coupling element to the blocking element and using the clamping element to move the plate towards the blocking element;
wherein each access door is connected to the housing via a support arm hinged on the outer face of the housing by a double hinge, the access door being configured to slide in the plane of the plate with respect to the support arm according to a sliding clearance when the clamping element is released, such that the coupling element is adapted to be uncoupled from the blocking element, when the clamping element is released, by sliding the access door with respect to the support arm.

15. A dust collector comprising:
a housing comprising an air inlet, an air outlet, and an inner separation wall separating the housing into a filtering chamber and a filtered air chamber, the air inlet opening onto the filtering chamber, the filtered air chamber leading to the exterior via the air outlet, at least one air flow opening being formed in the separation wall to establish a fluid communication between the filtering chamber and the filtered air chamber;
a filter cartridge arranged in the filtering chamber, the filter cartridge being in fluid communication with an air flow opening in the separation wall, the filter cartridge comprising:
a support having a first end connected to the separation wall and a second end opposite to the first end and carrying a blocking element;
a hollow filter, opened at its two ends, and sleeved on the support, a first end of the filter being sealingly arranged against the air flow opening in the separation wall such that there is a fluid communication between the interior of the filter and the air flow opening in the separation wall;
a hopper for collecting the dust formed in the bottom of the filtering chamber so as to collect the dust from the filtering of the filter cartridge; and
an access door for the filter cartridge, the access door opening onto the second end of the filter, the access door comprising:
a plate for covering the opening in the second end of the filter when the access door is closed;
a clamping element connected to the plate; and
a coupling element operably connected to the clamping element and configured to couple to the blocking element of the filter cartridge support, the plate being configured to seal the opening in the second end of the filter when the access door is closed by coupling the coupling element to the blocking element and using the clamping element to move the plate towards the blocking element;
wherein the access door is connected to the housing via a support arm hinged on the outer face of the housing by a double hinge, the access door being configured to slide in the plane of the plate with respect to the support arm according to a sliding clearance when the clamping element is released, such that the coupling element is adapted to be uncoupled from the blocking element, when the clamping element is released, by sliding the access door with respect to the support arm.
